(19) United States
(12) Patent Application Publication
(10) Pub. No.: US 2025/0265480 A1
(43) Pub. Date: Aug. 21, 2025

(54) MANAGING DATA SOURCE UNAVAILABILITY FOR AN INFERENCE MODEL

(71) Applicant: Dell Products L.P., Round Rock, TX (US)

(72) Inventors: OFIR EZRIELEV, Be'er Sheva (IL); JEHUDA SHEMER, Kfar Saba (IL); BORIS SHPILYUCK, Ashdod (IL)

(21) Appl. No.: 18/443,801

(22) Filed: Feb. 16, 2024

(51) Int. Cl. G06N 5/04

(52) U.S. Cl. CPC G06N 5/04

(57) ABSTRACT

Methods and systems for managing inference models are disclosed. Input data from one or more data sources associated with the inference model may become unavailable, which may impede inference generation by an inference model. The inference model may be made up of modular sub-network units and each data source may be associated with a sub-network unit. If one or more data sources becomes unavailable, the sub-network unit associated with the unavailable data source may be substituted with another sub-network unit. The replacement sub-network unit may duplicate operation of the sub-network unit within a threshold and may be previously trained so that the replacement sub-network unit is substituted into the inference model without re-training the inference model. By doing so, an updated inference model may be obtained, and inference generation may resume.

### FIELD

Embodiments disclosed herein relate generally to inference models. More particularly, embodiments disclosed herein relate to systems and methods to manage impact of unavailability of data sources on inference generation by inference models.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a block diagram illustrating a system in accordance with an embodiment.

FIGS. 2A-2G show an example inference model over time in accordance with an embodiment.

FIG. 3 shows a flow diagram illustrating a method of managing an inference model in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for managing an inference model. The inference model may generate inference model results (e.g., inferences) by ingesting input data from any number of data sources and may provide the inference model results to any number of downstream consumers. Therefore, reliable provision of computer-implemented services (e.g., inference generation) for the downstream consumers may rely on availability of input data from the data sources.

However, one or more data sources may become unavailable over time, causing an interruption to a flow of input data from the one or more data sources to the inference model. The one or more data sources may become unavailable for any reason including, for example, network connection interruptions, depowering of a data processing system associated with the one or more data sources (e.g., a data aggregator, a data collector), compromise of a data processing system associated with the one or more data sources, etc. An interruption to the flow of input data to the inference model may result in interruptions to and/or cessation of inference generation by the inference model. Consequently, provision of the computer-implemented services (e.g., inference generation) may be interrupted, which may negatively impact the downstream consumers.

To reduce interruptions to inference generation by the inference model in the event of unavailability of input data (e.g., from the one or more unavailable data sources), the inference model may be composed of modular sub-network units. The sub-network units may include portions of the inference model (e.g., input layers, trained latent representation generation units, other data processing units, intermediate layers, output layers) and may be modular so that a first sub-network unit may be substituted with a second sub-network unit as needed. For example, if a data source that supplies input data to the first sub-network unit becomes unavailable, the inference model may be modified so that the second sub-network unit is substituted for the first sub-network unit. The second sub-network unit may source input data from a set of data sources that does not include the one or more unavailable data sources associated with the first sub-network unit. The second sub-network unit may also be chosen based on a likelihood that the substitution will impact inference generation. Specifically, the second sub-network unit may be chosen so that an output (e.g., data, reduced-size representations of data) supplied by the second sub-network unit is similar to an output of the first sub-network unit within a threshold.

Thus, embodiments disclosed herein may provide an improved system for managing inference models so that interruptions to inference generation by the inference models are reduced in the event of at least a portion of input data becoming unavailable. Re-training at least a portion of the inference model in response to input data unavailability may consume an undesirable quantity of computing resources, may delay the provision of the computer-implemented services based on the inferences, and/or may otherwise negatively impact downstream consumers of the inferences. The disclosed embodiments may address this technical problem by substituting pre-trained modular (e.g., interchangeable) sub-network units of the inference model as needed in response to input data unavailability and/or otherwise loss of functionality of portions of the inference model.

In an embodiment, a method for managing an inference model that comprises sub-network units is provided. The method may include: making an identification that a portion of the inference model comprising one or more data sources of a first set of data sources is unavailable, the first set of the data sources providing first input data to a first sub-network unit of the sub-network units and when the one or more data sources are unavailable, the inference model is unable to generate an inference model result; making a first determination, in response to the identification, regarding whether a second sub-network unit duplicates operation of the first sub-network unit within a threshold, the second sub-network unit not being used by the inference model when the identification is made; in a first instance of the first determination in which the second sub-network unit duplicates the operation of the first sub-network unit within the threshold: replacing, at least temporarily, the first sub-network unit with the second sub-network unit to obtain an updated inference model; and executing the updated inference model to obtain the inference model result.

The method may also include: in a second instance of the first determination in which the second sub-network unit does not duplicate the operation of the first sub-network unit within the threshold: replacing, at least temporarily, the first sub-network unit with the second sub-network unit; replacing, at least temporarily, at least a third sub-network unit of the sub-network units with a fourth sub-network unit to obtain the updated inference model, the third sub-network unit being a portion of the inference model that sources second input data from the first sub-network unit and the fourth sub-network unit being intended to source third input data from the second sub-network unit; and executing the updated inference model to obtain the inference model result.

The second sub-network unit may source fourth input data from a second set of the data sources, the second set of the data sources being different from the first set of the data sources.

When a first data source of the first set of the data sources becomes unavailable, a second data source of the first set of the data sources may have an increased likelihood of becoming unavailable.

The first sub-network unit may include a first set of latent representation generation units and the second sub-network unit may include a second set of latent representation generation units.

Each latent representation generation unit of the first set of the latent representation generation units may be trained to generate a reduced-size representation of the first input data obtained from the first set of the data sources.

Making the first determination may include: obtaining the second sub-network unit from a sub-network unit repository; obtaining, using the second sub-network unit and the fourth input data obtained from the second set of the data sources, a first reduced-size representation of the fourth input data; comparing the first reduced-size representation of the fourth input data to an expected reduced-size representation of the second input data, the expected reduced-size representation of the second input data being generated by the first sub-network unit using the second input data obtained from the first set of the data sources; and in an instance of the comparing in which the first reduced-size representation of the fourth input data matches the expected reduced-size representation of the second input data within the threshold: concluding that the second sub-network unit duplicates the operation of the first sub-network unit within the threshold.

Prior to making the identification, the method may also include obtaining the inference model.

Obtaining the inference model may include: obtaining a plurality of data sources; for each data source of the plurality of the data sources: making a second determination, based on an intended use of fifth input data supplied by the data source and a quantity of the fifth input data supplied by the data source, regarding whether a latent representation of the fifth input data supplied by the data source is to be used; in a first instance of the second determination in which the latent representation of the fifth input data supplied by the data source is to be used: obtaining a latent representation generation unit; and obtaining a fifth sub-network unit that comprises the latent representation generation unit.

Obtaining the inference model may also include: in a second instance of the second determination in which the latent representation of the fifth input data supplied by the data source is not to be used: treating the fifth input data supplied by the data source as ingest for a sixth sub-network unit of the inference model, the fifth input data supplied by the data source not being fed into a latent representation generation unit prior to being used by the sixth sub-network unit.

Obtaining the inference model may also include: grouping data sources of the plurality of the data sources based on likelihoods of multiple of the data sources becoming unavailable at same points in time to obtain sets of data sources that comprise portions of the data sources that are likely to become unavailable at the same points in time, and the first set of data sources being one of the sets of the data sources; training, for the first set of the data sources, an autoencoder; and using a portion of the autoencoder as the first sub-network unit.

In an embodiment, a non-transitory media is provided. The non-transitory media may include instructions that when executed by a processor cause the computer-implemented method to be performed.

In an embodiment, a data processing system is provided. The data processing system may include the non-transitory media and a processor, and may perform the method when the computer instructions are executed by the processor.

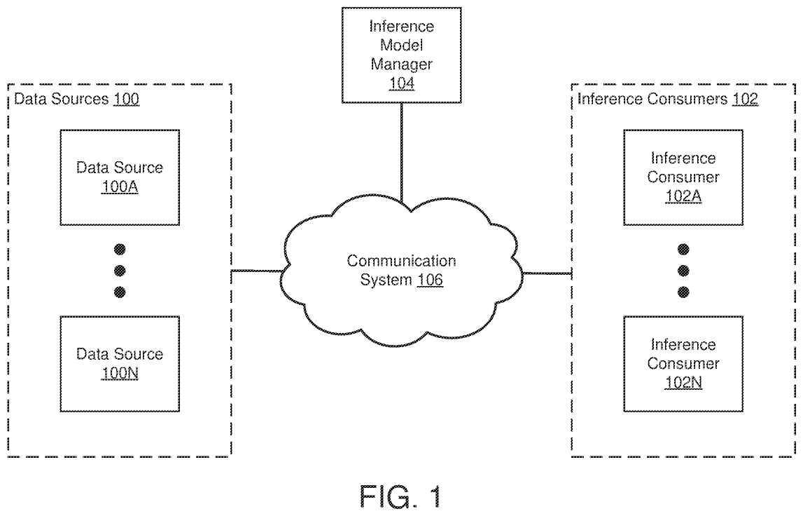

Turning to FIG. 1, a block diagram illustrating a system in accordance with an embodiment is shown. The system shown in FIG. 1 may provide computer-implemented services that may utilize inference models as part of the provided computer-implemented services.

The inference models may be artificial intelligence (AI) models and may include, for example, linear regression models, deep neural network models, and/or other types of inference generation models. The inference models may be used for various purposes. For example, the inference models may be trained to recognize patterns, automate tasks, and/or make decisions.

The computer-implemented services may include any type and quantity of computer-implemented services. The computer-implemented services may be provided by, for example, data sources 100, inference model manager 104, inference consumers 102, and/or any other type of devices (not shown in FIG. 1). Any of the computer-implemented services may be performed, at least in part, using inference models and/or inferences obtained with the inference models.

Data sources 100 may include any number of data sources (100A-100N) that may obtain (i) training data usable to train inference models, and/or (ii) ingest data that is ingestible into trained inference models to obtain corresponding inferences. The inferences generated by the inference models may be provided to inference consumers 102 for downstream use.

However, one or more of data sources 100 may become unavailable over time for any reason (e.g., compromise by a malicious entity, depowering of hardware resources, software component malfunction, network connectivity issues) and, therefore, input data may not be provided to the inference model as expected. An unexpected lack of input data for the inference model may interrupt inference generation and subsequent provision of the inferences to inference consumers 102. Such interruptions may negatively impact computer-implemented services obtained by and/or provided by inference consumers 102.

In general, embodiments disclosed herein may provide methods, systems, and/or devices for managing inference models so that interruptions to inference generation are reduced in the event of input data unavailability from one or more data sources of the inference model. By doing so, the system may be more likely to provide desired computer-implemented services due to increased uptime of the inference model.

To reduce interruptions to inference generation and, therefore, reduce interruptions to the computer-implemented services, the inference model may be made up of any number of sub-network units. Each sub-network unit may include a portion of the inference model (e.g., a portion of an autoencoder, a data processing unit, any number of layers of a neural network inference model). The sub-network units may be modular (e.g., may be substituted for other sub-network units) without requiring re-training processes for the sub-network units and/or the inference model.

To manage the inference model, the system may include inference model manager 104. Inference model manager 104 may manage any number of inference models. To do so, inference model manager 104 may: (i) oversee training processes to obtain trained inference models, (ii) manage inference model repositories, (iii) oversee inference generation by the inference models, (iv) perform remedial actions when one or more inference models does not perform as expected, and/or (v) perform other actions. For example, inference model manager 104 may perform actions to remediate unavailability of data sources 100.

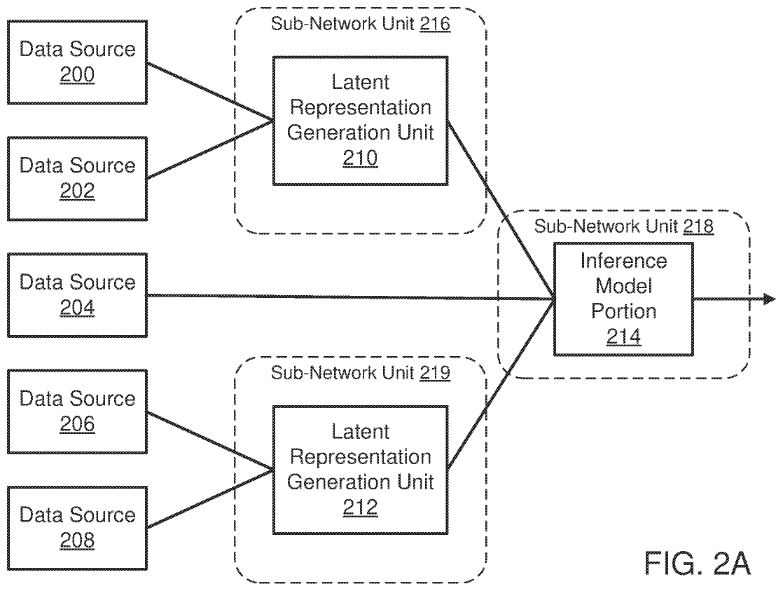

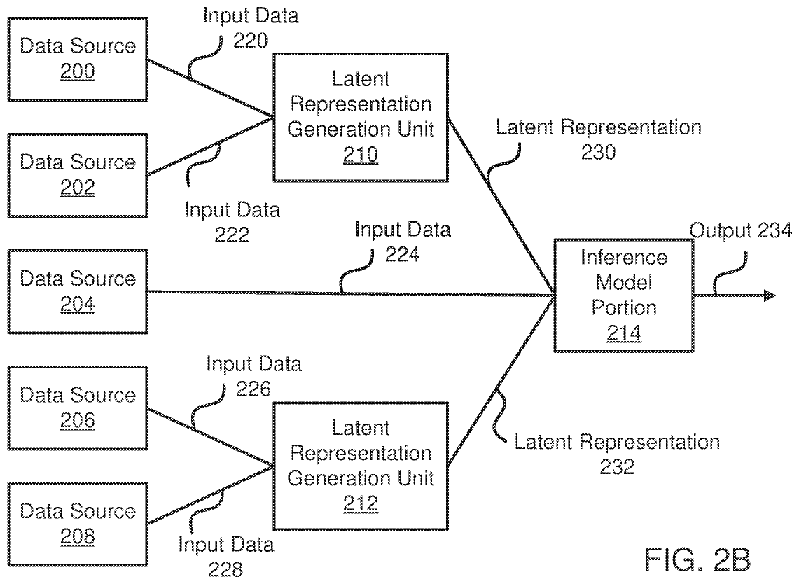

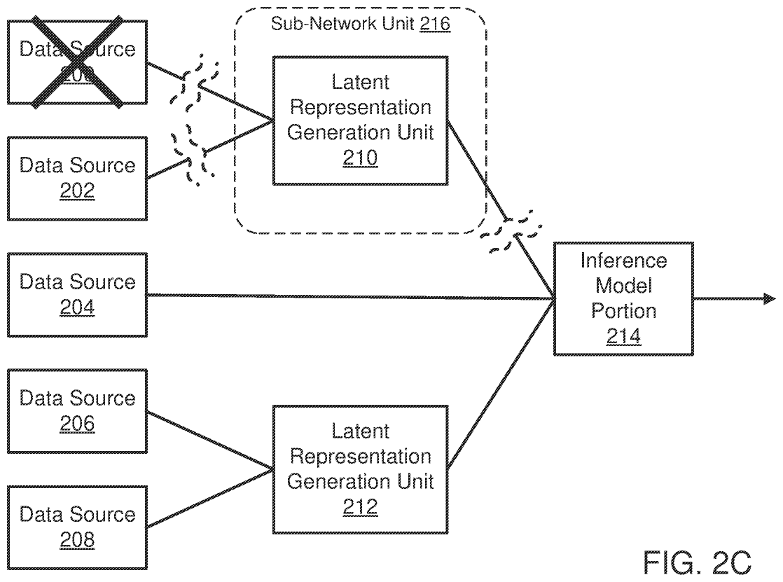

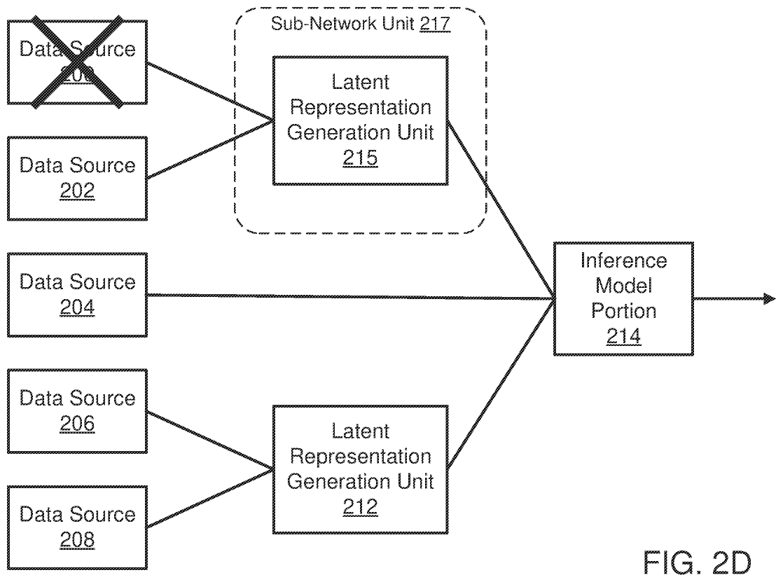

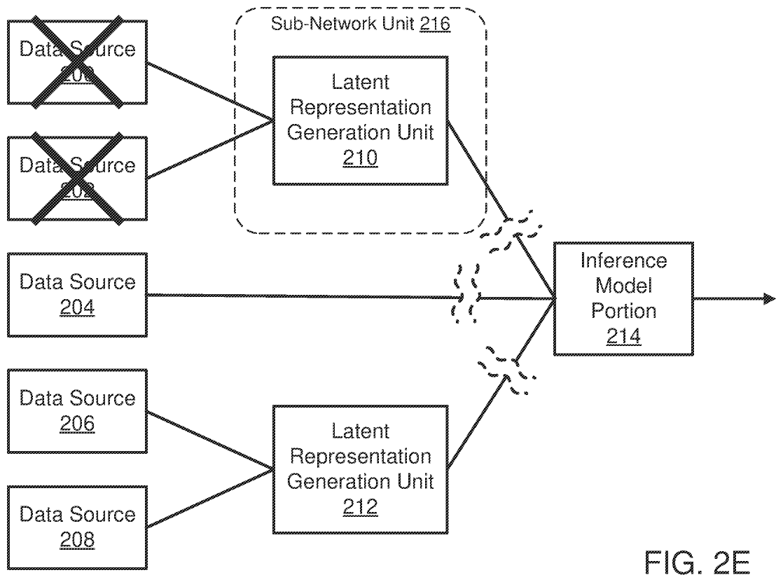

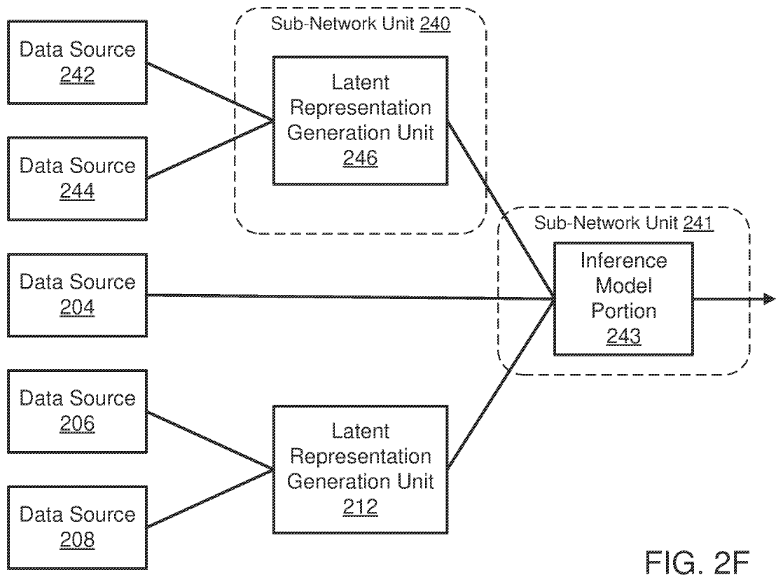

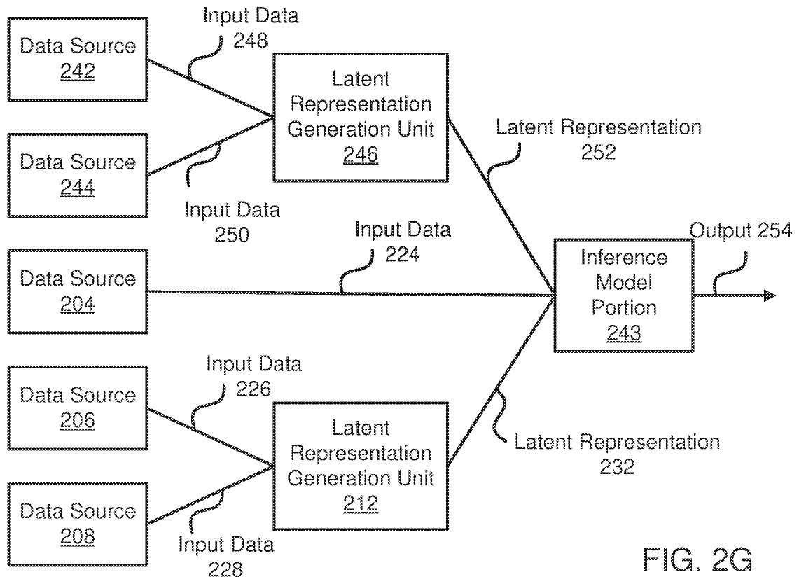

To obtain a trained inference model, inference model manager 104 may obtain any number of previously trained sub-network units (and/or may train any number of sub-network units) and may compile the sub-network units to generate the trained inference model. Refer to FIG. 2A for additional details regarding obtaining the trained inference model.

To remediate the unavailability of data sources 100, inference model manager 104 may: (i) identify that one or more data sources of a first set of data sources (e.g., of data sources 100) is unavailable, the first set of the data sources providing first input data to a first sub-network unit of the sub-network units, and/or (ii) determine whether a second sub-network unit duplicates operation of the first sub-network unit within a threshold.

If the second sub-network unit duplicates the operation of the first sub-network unit within the threshold, inference model manager 104 may: (i) replace, at least temporarily, the first sub-network unit with the second sub-network unit to obtain an updated inference model and (ii) execute the updated inference model to obtain an inference model result.

If the second sub-network unit does not duplicate the operation of the first sub-network unit within the threshold, inference model manager 104 may: (i) replace, at least temporarily, the first sub-network unit with the second sub-network unit, (ii) replace, at least temporarily, at least a third sub-network unit of the sub-network units with a fourth sub-network unit to obtain the updated inference model, and/or (iii) execute the updated inference model to obtain the inference model result.

The second sub-network unit may: (i) source input data from a second set of data sources (e.g., of data sources 100), the second set of the data sources being different from the first set of the data sources, (ii) may source input data from a portion of the first set of the data sources that is available (if any of the first set of the data sources are available), and/or (iii) may source input data from a combination of data sources (e.g., the portion of the first set of the data sources that is available, any supplementary data sources that may be used in place of the one or more unavailable data sources).

In addition, the second sub-network unit and the fourth sub-network unit may be previously trained and may not be used by the inference model at the time that the identification was made. The second sub-network unit and the fourth sub-network unit may be stored, for example, in a sub-network unit repository and may be retrieved (e.g., by inference model manager 104) in response to the identification. Therefore, by replacing the first sub-network unit with the second sub-network unit (and/or the third sub-network unit with the fourth sub-network unit), the unavailable data source(s) may be circumvented and inference generation (e.g., generation of inference model results) may resume.

Each sub-network unit (e.g., the first sub-network unit, the second sub-network unit, the third sub-network unit, the fourth sub-network unit) may each include a portion of an inference model. The portion of the inference model may include, for example, any number of layers of a neural network inference model, any number of latent representation generation units, and/or any other data processing unit usable by the inference model to facilitate inference generation. A latent representation generation unit may include, for example, a portion of an autoencoder trained to generate reduced-size representations of input data sourced from a set of data sources associated with the sub-network unit.

Therefore, determining whether the second sub-network unit duplicates the operation of the first sub-network unit within the threshold may include obtaining a first reduced-size representation of input data sourced from the second set of data sources and comparing the first reduced-size representation of the input data to an expected reduced-size representation of input data sourced from the first set of the data sources. The expected reduced-size representation of the input data may be generated by the first sub-network unit using input data obtained from the first set of the data sources (e.g., historic input data in the event of input data unavailability).

For example, the first sub-network unit may include a latent representation generation unit trained to ingest input data from the first set of the data sources to obtain a reduced-size representation of the input data from the first set of the data sources (e.g., a set of attributes of the input data). The second sub-network unit may duplicate the operation of the first sub-network unit within the threshold when the second sub-network unit generates a second set of attributes similar to the set of attributes when provided with similar ingest data.

Specifically, a first test ingest data set may be fed into the first sub-network unit. The first test ingest data set may include historic input data sourced from the first set of the data sources. A first test result may be obtained from the first sub-network unit and may indicate a set of attributes of the first test ingest data set. Similarly, a second test ingest data set may be fed into the second sub-network unit. The second test ingest data set may include historic and/or recently obtained data from the second set of the data sources. A second test result may be obtained from the second sub-network unit and may indicate a second set of attributes of the second test ingest data.

The first set of the attributes may be compared to the second set of the attributes and if a difference between the first set of the attributes and the second set of the attributes is within a threshold, the second sub-network unit may be treated as duplicating the operation of the first sub-network unit within the threshold. Determining whether the second sub-network unit duplicates the operation of the first sub-network unit within the threshold may be performed using other methods, other data sets, other metrics, and/or other types of thresholds without departing from embodiments disclosed herein.

For example, if at least a portion of the first set of the data sources is still available (following unavailability of another portion of the first set of the data sources), a test process may be performed to determine whether the second sub-network unit (and/or another sub-network unit) may duplicate the operation of the first sub-network unit within the threshold given ingest from only the portion of the first set of the data sources that is still available. If the second sub-network unit does duplicate the operation of the first sub-network unit within the threshold given the ingest data from the portion of the first set of the data sources within the threshold, the second sub-network unit may be substituted for the first sub-network unit without replacing other portions of the inference model (e.g., without replacing the first set of the data sources with the second set of the data sources and/or any other data sources).

The second sub-network unit may be chosen to replace the first sub-network unit based on any criteria. For example, data supplied by the second set of the data sources may be similar (e.g., within some other threshold and/or based on previously determined criteria) to data supplied by the currently unavailable first set of the data sources. For example, the data supplied by the second set of the data sources may be logically similar, may have similar attributes, etc. In addition, a second latent representation generation unit associated with the second sub-network unit may have similar properties (e.g., may have been trained using similar training data, may have been trained to ingest similar types and/or quantities of input data) to a first latent representation generation unit associated with the first sub-network unit.

If the second set of the data sources is to be used for inference generation (e.g., a portion of the first set of the data sources is not to be used), at least a third sub-network unit may also be replaced with a fourth sub-network unit. The third sub-network unit may be a portion of the inference model that previously utilized the first latent representation generated by the first sub-network unit as ingest. The third sub-network unit may be replaced due to the second sub-network unit not generating a latent representation of data that is ingestible by the third sub-network unit. This may be due to various differences in the number of attributes associated with the data, in the amount of data, and/or due to any other differences in data processing capabilities between the third and fourth sub-network units.

The fourth sub-network unit may be stored in the sub-network unit repository and may not be used by the inference model at the time the identification was made (e.g., that a data source has become unavailable). The fourth sub-network unit may be trained to ingest the latent representation of data generated by the second sub-network unit and may generate an output similar to the output previously generated by the third sub-network unit (e.g., within a second threshold). To determine compatibility of the fourth sub-network unit, tests may be performed similar to those performed to identify whether the second sub-network unit duplicated the operation of the first sub-network unit within the threshold. Therefore, various thresholds and/or test data sets may be utilized to determine whether the fourth sub-network unit is a compatible substitute for the third sub-network unit within the architecture of the inference model.

While described herein with respect to substituting two sub-network units (e.g., the first sub-network unit and the third sub-network unit) to remediate data source unavailability, it may be appreciated that any number of additional sub-network units of the inference model may be replaced to adapt to changes in availability of the input data. Refer to FIGS. 2A-2G for additional details regarding substituting modular sub-network units of the inference model.

To perform the above-mentioned functionality, the system of FIG. 1 may include data sources 100, inference model manager 104, inference consumers 102, and/or other entities. Data sources 100, inference consumers 102, inference model manager 104, and/or any other type of devices not shown in FIG. 1 may perform all, or a portion of the computer-implemented services independently and/or cooperatively.

Data sources 100 may include any number and/or type of data sources. Data sources 100 may include, for example, data collectors, data aggregators, data repositories, and/or any other entity responsible for providing input data to inference models. Data sources 100 may be grouped (e.g., by inference model manager 104 prior to obtaining the inference model and/or by another entity at another time) into any number of groupings. Groupings of data sources 100 may include any number of data sources 100. For example, a first grouping of data sources 100 may include two data sources of data sources 100 and a second grouping of data sources 100 may include five data sources of data sources 100.

Groupings of data sources 100 may be assigned so that members of a grouping are likely to become unavailable at same points in time. The groupings of data sources 100 may be assigned based on other criteria including, for example, logical similarities in the input data sourced from data sources within the grouping so that data processing requirements for the input data may be reduced, etc. Refer to FIG. 2A for additional details regarding groupings of data sources 100.

Inference consumers 102 may provide, all or a portion, of the computer-implemented services. When doing so, inference consumers 102 may consume inferences obtained by inference model manager 104 (and/or other entities using inference models managed by inference model manager 104). However, if inferences from inference models are unavailable, then inference consumers 102 may be unable to provide, at least in part, the computer-implemented services, may provide less desirable computer-implemented services, and/or may otherwise be impacted in an undesirable manner.

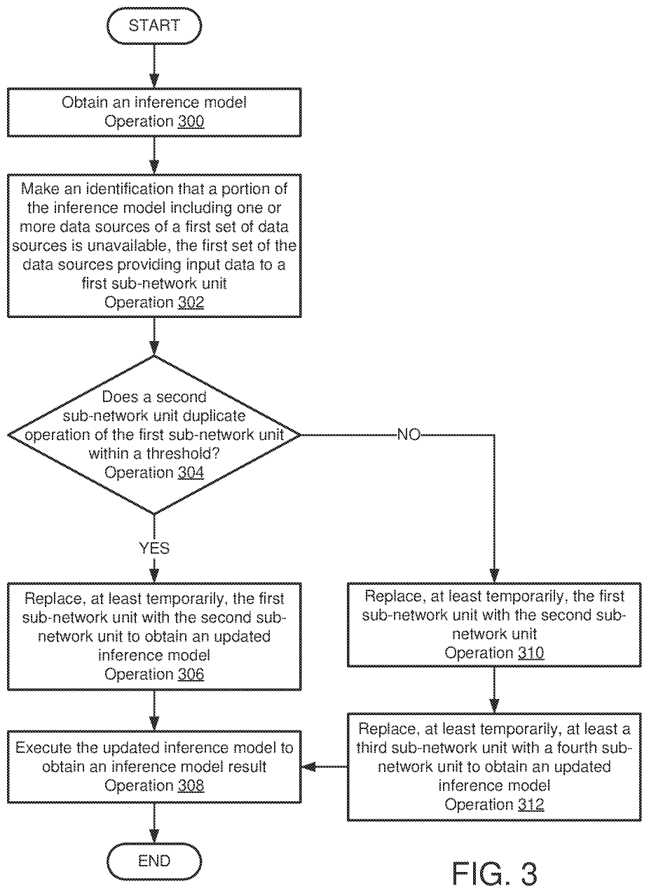

When performing its functionality, one or more of inference model manager 104, data sources 100, and inference consumers 102 may perform all, or a portion, of the methods and/or actions shown in FIGS. 2A-3.

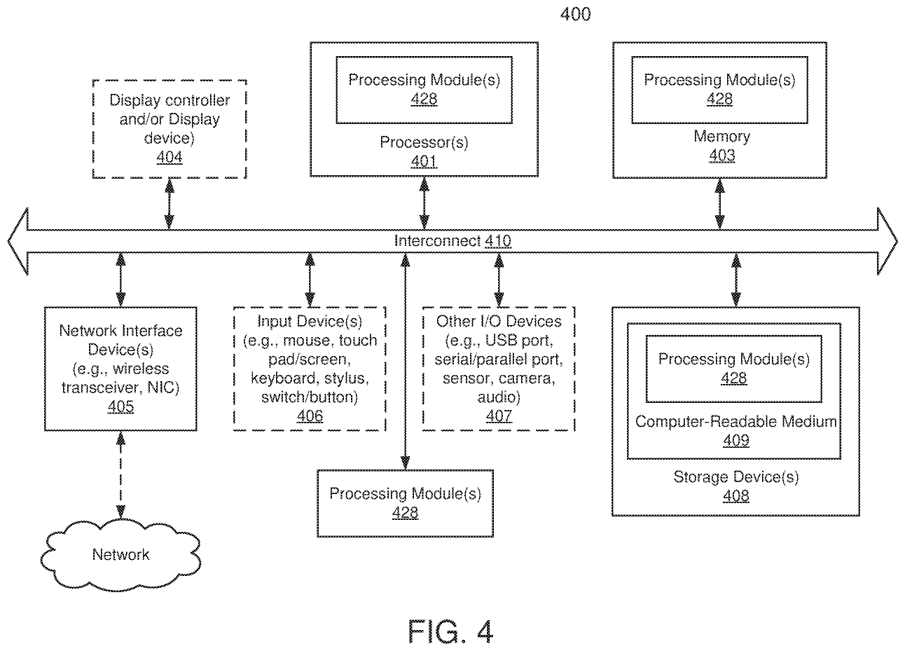

Any of inference model manager 104, data sources 100, and inference consumers 102 may be implemented using a computing device (e.g., a data processing system) such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system. For additional details regarding computing devices, refer to FIG. 4.

Any of the components illustrated in FIG. 1 may be operably connected to each other (and/or components not illustrated) with communication system 106.

Communication system 106 may include one or more networks that facilitate communication between any number of components. The networks may include wired networks and/or wireless networks (e.g., and/or the Internet). The networks may operate in accordance with any number and types of communication protocols (e.g., such as the internet protocol).

Communication system 106 may be implemented with one or more local communications links (e.g., a bus interconnecting a processor of inference model manager 104 and any of the data sources 100, and inference consumers 102).

While illustrated in FIG. 1 as included a limited number of specific components, a system in accordance with an embodiment may include fewer, additional, and/or different components than those illustrated therein.

The system described in FIG. 1 may be used to reduce the computational cost for mitigating the impact of (input) data unavailability for inference models on inference consumers. The following processes described in FIGS. 2A-2G may be performed by the system in FIG. 1 when providing this functionality.

Turning to FIG. 2A, an example architecture of an inference model that includes sub-network units is shown. The inference model in FIG. 2A is shown as sourcing input data from five data sources (e.g., 200, 202, 204, 206, and 208). However, it may be appreciated that an inference model may source input data from any number of data sources without departing from embodiments disclosed herein. Each of the five data sources shown may represent any entity from which input data is obtained for the inference model. For example, data source 200 may be a data collector, a data aggregator, a data repository, a device storing any amount of data in storage, and/or any other entity.

To obtain the inference model architecture shown in FIG. 2A, data sources 200-208 may be divided into three groupings. For example, a first grouping may include data source 200 and data source 202, a second grouping may include data source 204, and a third grouping may include data source 206 and 208. The groupings may be formed based on any criteria including, for example, a likelihood that each data source will become unavailable at a same point in time, logical similarities between data sourced from each data source, etc. Specifically, data source 200 and data source 202 may have a highest likelihood (when compared to data sources 204, 206 and 208) of becoming unavailable at a first point in time and data sources 204-208 may be less likely to become unavailable at the first point in time.

Data source 200 and data source 202 may have the highest likelihood of becoming unavailable at the first point in time due to any criteria. For example, data source 200 and data source 202 may be data collectors including sensors positioned in a first ambient environment. A weather event (e.g., a storm) may occur in the first ambient environment and data source 200 and data source 202 may be equally impacted by the weather event. However, data source 204 may be a data collector located in a second ambient environment that is not proximate to the first ambient environment. Therefore, data source 204 may be unlikely to be impacted by the weather event and may not be included in the first grouping.

Following grouping data sources 200-208, it may be determined (e.g., by a user, by inference model manager 104 via any set of rules, by another entity) whether reduced-size representations of input data sourced from each grouping of data sources 200-208 are to be used.

For example, data source 200 and data source 202 together may generate a large quantity of input data and, therefore, a reduced-size representation of the large quantity of the input data may be favored for use in inference generation. Similarly, a network connection between data sources 200-202 and an entity hosting the inference model may have limited bandwidth available for transmission of the large quantity of the input data. Therefore, a reduced-size representation of the large quantity of the input data may be more easily transmitted to the entity hosting the inference model to use for inference generation.

It may be determined, therefore, that a reduced-size representation of input data from the first grouping (e.g., including data source 200 and data source 202) is to be generated prior to inference generation. To do so, latent representation generation unit 210 may be obtained.

To obtain latent representation generation unit 210, a first autoencoder may be trained using a first set of training data (e.g., from data source 200 and/or data source 202). Training the first autoencoder may include performing any training process using the first set of the training data so that a first set of weights for the first autoencoder are obtained. The first set of the weights may be iteratively modified until a latent representation (e.g., the reduced-size representation) of the first set of the training data may be generated and subsequently used to faithfully re-create the first set of the training data within a threshold.

A portion of the first autoencoder (e.g., including the weights usable to generate the latent representation) may be treated as latent representation generation unit 210. Therefore, input data sourced from data source 200 and data source 202 may be fed into latent representation generation unit 210 to obtain a latent representation of the input data, which may then be provided to inference model portion 214.

Latent representation generation unit 210 may be obtained via other methods and may generate reduced-size representations of data via other means (e.g., other than a portion of an autoencoder) without departing from embodiments disclosed herein.

Inference model portion 214 may include: (i) any number of sub-network units, (ii) any number of layers of a neural network inference model, and/or (iii) other data processing units usable to facilitate inference generation. Refer to FIG. 2B for an example inference generation process for the inference model.

It may also be determined that a reduced-size representation of input data from a second grouping (e.g., including data source 206 and data source 208) is to be generated prior to inference generation. To do so, latent representation generation unit 212 may be obtained using methods similar to those described with respect to latent representation generation unit 210.

Therefore, input data sourced from data source 206 and data source 208 may be fed into latent representation generation unit 212 to obtain a latent representation of the input data, which may then be provided to inference model portion 214 for further processing.

Lastly, it may be determined that a reduced-size representation of input data from a third grouping (e.g., including data source 204) is not to be generated prior to inference generation. Therefore, input data sourced from data source 204 may be fed directly into inference model portion 214 to be used for inference generation.

As previously mentioned, the inference model may include any number of sub-network units. The inference model described in FIG. 2A may include three sub-network units (e.g., sub-network unit 216, sub-network unit 218, and sub-network unit 219). Each sub-network unit may include at least a portion of the inference model. Specifically, sub-network unit 216 may include at least latent representation generation unit 210, sub-network unit 218 may include at least inference model portion 214, and sub-network unit 219 may include at least latent representation generation unit 212. While the inference model described in FIG. 2A is shown as including three sub-network units, it may be appreciated that inference models may include any number of sub-network units without departing from embodiments disclosed herein.

Turning to FIG. 2B, an example data flow during inference generation by the inference model described in FIG. 2A is shown.

Data source 200 may provide input data 220 to latent representation generation unit 210 and data source 202 may provide input data 222 to latent representation generation unit 210. Input data 220 and input data 222 may include any quantity and/or type of data usable by the inference model for inference generation. Although not shown in FIG. 2B, the inference model may include other elements such as, for example, any number of input layers of a neural network. Latent representation generation unit 210 may use input data 220 and input data 222 to generate latent representation 230.

To do so, latent representation generation unit 210 may include a portion of an autoencoder and may be trained to generate reduced-size representations of input data. Latent representation 230, therefore, may include a reduced-size representation of input data 220 and/or input data 222. The reduced-size representation may include, for example, attributes of input data 220 and input data 222. Refer to FIG. 2A for additional details regarding groupings of data sources for particular latent representation generation units. Latent representation 230 may be provided to inference model portion 214.

Data source 204 may provide input data 224 directly to inference model portion 214 without traversing a latent representation generation unit. This may occur due to, for example, a quantity and/or type of data included in input data 224. Specifically, data source 204 may generate less data than data source 200 and/or data source 202 and/or a type of data that is provided by data source 204 may be preferred to not be in the form of a latent representation (for any reason). While not shown in FIG. 2B, input data 224 may pass through additional inference model portions (e.g., including any number of input layers, any number of intermediate layers) prior to being fed into inference model portion 214.

Data source 206 may provide input data 226 to latent representation generation unit 212 and data source 208 may provide input data 228 to latent representation generation unit 212. Data sources 206 and 208 may be similar to any of data sources 200, 202, and/or 204. Latent representation generation unit 212 may be similar to latent representation generation unit 210. Latent representation generation unit 212 may generate, based on input data 226 and input data 228, latent representation 232 which may be provided to inference model portion 214.

Latent representation 230 may be fed into inference model portion 214 and may be used (along with input data 224 from data source 204 and latent representation 232 from latent representation generation unit 212) by inference model portion 214 to generate output 234. Inference model portion 214 may include any portion of the inference model including any number of sub-network units, any number of intermediate layers of a neural network, additional data processing units, etc. Output 234 may include at least partially processed data based on input data and latent representations of input data. Specifically, output 234 may be partially processed due to output 234 being fed into another sub-network unit (not shown in FIGS. 2A-2G) and/or other portions of the inference model to facilitate inference generation by the inference model.

Thus, the inference model depicted in FIG. 2B may process data as a portion of an inference generation process using input data from any number of data sources and using some number of latent representation generation units to modify at least a size of input data from a portion of the data sources. By associating data sources with trained latent representation generation units, portions of the inference model (e.g., sub-network units) may be modular. In other words, if a data source associated with the inference model becomes unavailable, a latent representation generation unit associated with the unavailable data source may be replaced with a similar latent representation generation unit. However, to do so, the inference model may be divided into any number of modular sub-network units including previously trained latent representation generation units. Refer to FIG. 2A for a visual depiction of the inference model divided into sub-network units.

Turning to FIG. 2C, consider a first scenario in which data source 200 becomes unavailable while data source 202 remains available. Data source 200 may include a data collector that becomes unavailable due to, for example, a weather event impacting an environment in which data source 200 is positioned.

If data source 200 becomes unavailable, latent representation generation unit 210 may be unable to generate a latent representation (e.g., a reduced-size representation) to provide to inference model portion 214. Therefore, sub-network unit 216 may have limited functionality within the architecture of the inference model.

If the functionality of sub-network unit 216 is limited (or non-existent), the inference model may not be able to generate an inference model result (and/or may generate inference model results with a reduced level of accuracy to a degree that is considered unacceptable by inference consumers, etc.).

To reduce downtime of the inference model and, subsequently, to reduce downtime for provision of computer-implemented services, sub-network unit 216 may be replaced in the inference model architecture with another sub-network unit capable of generating a result considered usable by the inference model to resume inference generation.

Turning to FIG. 2D, sub-network unit 216 may be removed from the inference model. Sub-network unit 216 may be removed permanently and/or temporarily. Sub-network unit 216 may be replaced in the inference model architecture with sub-network unit 217. Sub-network unit 217 may not have been used by the inference model at the time that data source 200 became unavailable. In addition, sub-network unit 217 may be retrieved from storage in a sub-network unit repository.

Sub-network unit 217 may source input data from data source 202 and may include latent representation generation unit 215. Latent representation generation unit 215 may be a portion of a previously trained autoencoder trained to generate latent representations of input data sourced from data sources.

Sub-network unit 217 may be eligible to replace sub-network unit 216 in the inference model architecture if sub-network unit 217 duplicates operation of sub-network unit 216 within a threshold. The threshold may be any threshold, may be based on needs of one or more inference consumers, and may be determined by any entity (e.g., a manufacturer, a user, a downstream consumer, a third-party service).

To determine whether sub-network unit 217 duplicates the operation of sub-network unit 216 within the threshold, input data sourced from data source 202 (e.g., input data 222 shown in FIG. 2B) may be used to generate a first reduced-size representation of input data 222. The first reduced-size representation of input data 222 may be compared to an expected reduced-size representation of the input data (not shown). The expected reduced-size representation of the input data may be previously generated and stored in storage, may be generated using historic input data sourced from data sources 200 and/or 202 and latent representation generation unit 210, and/or may be generated via another method. The expected reduced-size representation of the input data may be intended to represent the operation of sub-network unit 216.

A difference may be obtained between the first reduced-size representation of input data 222 and the expected reduced-size representation of the input data, and the difference may be compared to the threshold (not shown). If the difference falls below the threshold, sub-network unit 217 may be substituted for sub-network unit 216 in the inference model architecture. If the difference does not fall below the threshold, sub-network unit 217 may not be considered an adequate substitute for sub-network unit 216.

In the event that sub-network unit 217 is not considered an adequate substitute for sub-network unit 216, additional portions of the inference model may be considered for substitution (e.g., data source 202, at least a portion of inference model portion 214 and/or other portions not shown in FIG. 2D) in order to duplicate the operation of sub-network unit 216 within the threshold.

Turning to FIG. 2E, consider a second scenario in which data source 200 and data source 202 become unavailable. Data source 200 and data source 202 may include data collectors that may become unavailable due to, for example, a weather event impacting an environment in which data source 200 and data source 202 are positioned.

If data source 200 and data source 202 become unavailable, latent representation generation unit 210 may be unable to generate a latent representation (e.g., a reduced-size representation) to provide to inference model portion 214. Therefore, sub-network unit 216 may have limited functionality within the architecture of the inference model.

If the functionality of sub-network unit 216 is limited (or non-existent), the inference model may not be able to generate an inference model result (and/or may generate inference model results with a reduced level of accuracy to a degree that is considered unacceptable by inference consumers, etc.).

To reduce downtime of the inference model and, subsequently, to reduce downtime for provision of computer-implemented services, sub-network unit 216 may be replaced in the inference model architecture with another sub-network unit capable of generating a result considered usable by the inference model to resume inference generation.

Turning to FIG. 2F, sub-network unit 216 (and corresponding data sources 200 and 202) may be removed from the inference model. Sub-network unit 216 may be removed permanently and/or temporarily. Sub-network unit 216 may be replaced in the inference model architecture with sub-network unit 240. Sub-network unit 240 may not have been used by the inference model at the time that data source 200 and data source 202 became unavailable. In addition, sub-network unit 240 may be retrieved from storage in a sub-network unit repository.

Sub-network unit 240 may have two corresponding data sources from which to source input data from (e.g., data source 242 and data source 244). Data source 242 and data source 244 may be available and, therefore, may be able to provide input data to sub-network unit 240. Sub-network unit 240 may include latent representation generation unit 246. Latent representation generation unit 246 may be a portion of a previously trained autoencoder trained to generate latent representations of input data sourced from data sources.

Sub-network unit 240 may be eligible to replace sub-network unit 216 in the inference model architecture if sub-network unit 240 duplicates operation of sub-network unit 216 within a threshold. The threshold may be any threshold, may be based on needs of one or more inference consumers, and may be determined by any entity (e.g., a manufacturer, a user, a downstream consumer, a third-party service). Sub-network unit 240 may also be eligible to replace sub-network unit 216 based on other criteria including, for example, a type and/or quantity of data supplied by data sources 242 and 244 being similar (e.g., based on another threshold) to a type and/or quantity of data expected to be supplied by data sources 200 and 202, etc.

To determine whether sub-network unit 240 duplicates the operation of sub-network unit 216 within the threshold, input data sourced from data sources 242 and/or 244 may be used to generate a second reduced-size representation of data. The second reduced-size representation of the data may be compared to an expected reduced-size representation of the input data (not shown). The expected reduced-size representation of the input data may be previously generated and stored in storage, may be generated using historic input data sourced from data sources 200 and/or 202 and latent representation generation unit 210, and/or may be generated via another method. The expected reduced-size representation of the input data may be intended to represent the operation of sub-network unit 216.

A difference may be obtained between the second reduced-size representation of the data and the expected reduced-size representation of the input data and the difference may be compared to the threshold (not shown). If the difference falls below the threshold, sub-network unit 240 may be substituted for sub-network unit 216 in the inference model architecture. If the difference does not fall below the threshold, sub-network unit 240 may not be considered an adequate substitute for sub-network unit 216.

In the event that sub-network unit 240 is not considered an adequate substitute for sub-network unit 216 (e.g., due to differences in dimensionality between an output from sub-network unit 240 and an output that may be ingested by sub-network unit 218), additional portions of the inference model may be considered for substitution (e.g., at least a portion of inference model portion 214 and/or other portions not shown in FIG. 2F) in order to duplicate the operation of sub-network unit 216 within the threshold.

For example, inference model portion 214 may not be able to ingest a latent representation of data generated by sub-network unit 240 (e.g., due to characteristics of the latent representation of data generated by sub-network unit 240 such as a dimensionality). Therefore, sub-network unit 218 (shown in FIG. 2A) may be replaced with sub-network unit 241. Sub-network unit 241 may include inference model portion 243. Inference model portion 243 may include any previously trained data processing portion of the inference model (e.g., including any number of intermediate layers of a neural network, any number of additional sub-network units) trained to ingest input data from sub-network unit 240, data source 204, and sub-network unit 219.

To determine whether sub-network unit 218 may be replaced with sub-network unit 241, tests similar to those described with respect to sub-network unit 240 may be performed. Specifically, sub-network unit 218 may be replaced with sub-network unit 241 if inference model portion 243 duplicates operation of inference model portion 214 within a second threshold, etc.

While described with respect to replacing two sub-network units of the inference model, additional sub-network units other than those shown and described in FIGS. 2A-2G may be substituted as needed to manage data source unavailability without departing from embodiments disclosed herein.

Turning to FIG. 2G, an example updated inference model is shown. The updated inference model may be updated based on sub-network unit 240 being considered an adequate substitute for sub-network unit 216 and sub-network unit 241 being considered an adequate substitute for sub-network unit 218. To resume inference generation, data source 242 may provide input data 248 to latent representation generation unit 246 and data source 244 may provide input data 250 to latent representation generation unit 246. Input data 248 and input data 250 may include any quantity and type of data usable by the inference model for inference generation. Latent representation generation unit 246 may use input data 248 and input data 250 to generate latent representation 252.

To do so, latent representation generation unit 246 may include a portion of an autoencoder and may be trained to generate reduced-size representations of input data. Latent representation 252, therefore, may include a reduced-size representation of input data 248 and/or input data 250. The reduced-size representation may include, for example, attributes of input data 248 and input data 250. Latent representation 252 may be provided to inference model portion 243.

Data source 204 may provide input data 224 directly to inference model portion 243 without traversing a latent representation generation unit as described in FIG. 2B.

Data source 206 may provide input data 226 to latent representation generation unit 212 and data source 208 may provide input data 228 to latent representation generation unit 212 as described in FIG. 2B.

Latent representation 252 may be fed into inference model portion 243 and may be used (along with input data 224 from data source 204 and latent representation 232 from latent representation generation unit 212) by inference model portion 243 to generate output 254. Output 254 may include any amount of partially processed data that may be used by additional (not shown) sub-network units of the inference model to as a part of inference generation by the inference model.

In an embodiment, the one or more entities performing the operations shown in FIGS. 2A-2G are implemented using a processor adapted to execute computing code stored on a persistent storage that when executed by the processor performs the functionality of the system of FIG. 1 discussed throughout this application. The processor may be a hardware processor including circuitry such as, for example, a central processing unit, a processing core, or a microcontroller. The processor may be other types of hardware devices for processing information without departing from embodiments disclosed herein.

As discussed above, the components of FIG. 1 may perform various methods to manage inference models. FIG. 3 illustrates methods that may be performed by the components of FIG. 1. In the diagrams discussed below and shown in FIG. 3, any of the operations may be repeated, performed in different orders, and/or performed in parallel with or in a partially overlapping in time manner with other operations.

Turning to FIG. 3, a flow diagram illustrating a method of managing an inference model in accordance with an embodiment is shown. The method may be performed by a data processing system, inference model manager, data source, inference consumer, and/or another device.

At operation 300, an inference model may be obtained. Obtaining the inference model may include obtaining a plurality of data sources and for each data source of the plurality of the data sources: determining, based on an intended use of input data supplied by the data source and a quantity of the input data supplied by the data source, whether a latent representation of the input data supplied by the data source is to be used.

Obtaining the plurality of the data sources may include: (i) reading a list of identifiers for available data sources from storage, (ii) receiving a list of available data sources from another entity (e.g., a data source management system, the data sources), (iii) receiving contact information for the plurality of the data sources (e.g., a media access control (MAC) address usable to address communications to each of the plurality of the data sources) from another entity, and/or (iv) other methods.

Determining whether the latent representation of the input data supplied by the data source is to be used may include: (i) obtaining metadata associated with the input data supplied by the data source, and/or (ii) comparing attributes of the metadata to any criteria to determine whether the latent representation is to be used. For example, the metadata may indicate that a certain quantity of input data is received from the data source on average each day and the quantity of the input data may exceed a criterion for a desired rate of input data acquisition. In addition, the metadata may indicate a quantity of communication system bandwidth consumed during transmission of the input data. The quantity of the communication system bandwidth consumed may be compared to a bandwidth threshold to indicate whether sufficient communication system bandwidth is available to transmit the input data supplied by the data source, etc.

If a latent representation of the input data is to be used, obtaining the inference model may also include: (i) obtaining a latent representation generation unit and (ii) obtaining a third sub-network unit that includes the latent representation generation unit.

Obtaining the latent representation generation unit may include: (i) training an autoencoder using the input data from the data source to obtain a trained autoencoder, (ii) obtaining a portion of the autoencoder (e.g., a portion that obtains a latent representation) and/or (iii) treating the portion of the autoencoder as the latent representation generation unit.

Obtaining the latent representation generation unit may also include: (i) reading an algorithm (e.g., the portion of the autoencoder, another algorithm) capable of generating reduced-size representations of data from storage, (ii) receiving the algorithm from another entity, and/or (iii) other methods.

Obtaining the third sub-network unit may include: (i) encapsulating the latent representation generation unit in a data structure, (ii) treating the encapsulated latent representation generation unit (along with metadata including indicators for the associated data sources, etc.) as the third sub-network unit, and/or (iii) storing the third sub-network unit in a sub-network unit repository. If the third sub-network unit is used for inference generation, the third sub-network unit may: (i) request input data from the data source, (ii) generate, using the portion of the autoencoder, a reduced-size representation of the input data, and/or (iii) provide the reduced-size representation of the input data to another sub-network unit of the inference model.

If the latent representation of the input data is not to be used, obtaining the inference model may also include treating the input data supplied by the data source as ingest for a fourth sub-network unit of the inference model, the input data supplied by the data source not being fed into a latent representation generation unit prior to being used by the fourth sub-network unit. Treating the input data as ingest for a fourth sub-network unit may include: (i) obtaining input data from the data source, (ii) providing, without feeding the input data into a portion of an autoencoder, the input data to a fourth sub-network unit, the fourth sub-network unit including a portion of the inference model. The portion of the inference model may include, for example, any number of layers of a neural network inference model.

Treating the input data as ingest for the fourth sub-network unit may also include modifying instructions associated with execution of the inference model, the instructions indicating that input data from the data source is to be provided directly to the fourth sub-network unit, etc.

Obtaining the inference model may also include: (i) grouping data sources of the plurality of the data sources based on likelihoods of multiple of the data sources becoming unavailable at same points in time to obtain sets of data sources that include portions of the data sources that are likely to become unavailable at same points in time, and the first set of the data sources being one of the sets of the data sources, (ii) training, for the first set of the data sources, an autoencoder, and/or (iii) using a portion of the autoencoder as the first sub-network unit.

Grouping the data sources may include: (i) identifying characteristics of each data source of the data sources, and/or (ii) performing an analysis process using the identified characteristics to obtain any number of sets of the data sources, each set of the sets of the data sources including data sources with similar characteristics. For example, a first grouping of the data sources may include data sources located in a similar geographic area.

Training the autoencoder may include performing any training process using an autoencoder and input data from the first set of the data sources to obtain a set of optimized weights for the autoencoder, the set of the optimized weights being chosen so that the autoencoder faithfully (e.g., within a threshold) re-creates the input data from the first set of the data sources after generating a latent representation of the input data.

Using the portion of the autoencoder as the first sub-network unit may include: (i) obtaining the portion of the autoencoder, the portion of the autoencoder including the weights usable to generate the latent representation, and/or (ii) storing the portion of the autoencoder in a sub-network unit repository. Storing the portion of the autoencoder in the sub-network unit repository may include generating metadata for the portion of the autoencoder, the metadata indicating at least which data sources are associated with the first sub-network unit and storing the metadata along with the portion of the autoencoder.

At operation 302, an identification may be made that a portion of the inference model comprising one or more data sources of a first set of data sources is unavailable, the first set of the data sources providing first input data to a first sub-network unit. Making the identification may include: (i) reading a notification that the one or more data sources are unavailable from storage, (ii) receiving an alert indicating a lack of expected input data from the one or more data sources, (iii) providing a test message to the one or more data sources and not receiving an expected response, and/or (iv) other methods.

Making the identification may also include identifying that one or more sub-network units of the inference model are unavailable (e.g., the portion of the inference model may include the one or more sub-network units). For example, the portion of the inference model may include the first sub-network unit.

At operation 304, it may be determined whether a second sub-network unit duplicates operation of the first sub-network unit within a threshold. Making the determination may include: (i) obtaining the second sub-network unit from a sub-network unit repository, (ii) obtaining, using the second sub-network unit and fourth input data obtained from the second set of the data sources, a first reduced-size representation of the fourth input data, and/or (iii) comparing the first reduced-size representation of the fourth input data to an expected reduced-size representation of the second input data, the expected reduced-size representation of the second input data being generated by the first sub-network unit using the second input data obtained from the first set of the data sources. If the first reduced-size representation of the fourth input data matches the expected reduced-size representation of the second input data within the threshold, making the determination may also include concluding that the second sub-network unit duplicates the operation of the first sub-network unit within the threshold.

Obtaining the second sub-network unit from the sub-network repository may include: (i) searching the sub-network unit repository using search criteria to obtain search results, the search criteria including characteristics of data sources and/or latent representation generation units similar to those associated with the first sub-network unit, and/or (ii) selecting the second sub-network unit from the search results, the search results including any number of sub-network units. Obtaining the second sub-network unit may also include querying another entity responsible for searching the sub-network unit repository for potential replacement sub-network units.

Obtaining the first reduced-size representation of the fourth input data may include: (i) obtaining a test data set, the test data set including any amount of input data sourced from the second set of the data sources, (ii) feeding the test data set into a latent representation generation unit associated with the second sub-network unit, and/or (iii) reading the first reduced-size representation of the fourth input data from an output of the latent representation generation unit.

Comparing the first reduced-size representation of the fourth input data to the expected reduced-size representation of the second input data may include: (i) obtaining the expected reduced-size representation of the second input data, (ii) obtaining a difference between the first reduced-size representation of the fourth input data and the expected reduced-size representation of the second input data, (iii) obtaining the threshold, and/or (iv) comparing the difference to the threshold.

Obtaining the expected reduced-size representation of the second input data may include: (i) obtaining the second input data from the first set of the data sources, (ii) feeding the second input data from the first set of the data sources into the first sub-network unit, and/or (iii) treating an output of a latent representation generation unit associated with the first sub-network unit as the expected reduced-size representation of the second input data.

If the second sub-network unit duplicates the operation of the first sub-network unit within the threshold, the method may proceed to operation 306. If the second sub-network unit does not duplicate the operation of the first sub-network unit within the threshold, the method may proceed to operation 310.

At operation 306, the first sub-network unit may be replaced, at least temporarily, with the second sub-network unit to obtain an updated inference model. Replacing the first sub-network unit with the second sub-network unit may include: (i) storing the first sub-network unit in the sub-network unit repository, (ii) adding the second sub-network unit to the inference model, (iii) modifying instructions for execution of the inference model so that the second sub-network unit begins requesting input data from the second set of the data sources and provides latent representations of the requested input data to another portion of the inference model, and/or (iv) other methods.

At operation 308, the updated inference model may be executed to obtain an inference model result. Executing the updated inference model may include: (i) obtaining input data from any number of data sources, (ii) executing instructions (e.g., to generate latent representations of the input data) to generate an inference, and/or (iii) providing the inference to an inference consumer.

The method may end following operation 308.

Returning to operation 304, the method may proceed to operation 310 if the second sub-network unit does not duplicate the operation of the first sub-network unit within the threshold.

At operation 310, the first sub-network unit may be replaced, at least temporarily, with the second sub-network unit using methods similar to those described with respect to operation 306.

At operation 312, at least a third sub-network unit may be replaced, at least temporarily, with a fourth sub-network unit to obtain an updated inference model. The third sub-network unit may be a portion of the inference model that previously sourced the second input data from the first sub-network unit. As the second sub-network unit was not determined as an adequate substitute for the first sub-network unit (in this scenario), the latent representation of the second input data generated by the second sub-network unit may not be ingestible by the third sub-network unit to produce an output similar (e.g., within a second threshold) to an output based on the latent representation of the second input data previously generated by the first sub-network unit.

The fourth sub-network unit may be intended to source fourth input data from the second sub-network unit and may be intended to duplicate operation of the third sub-network unit within the second threshold. Replacing the third sub-network unit with the fourth sub-network unit may include: (i) obtaining the fourth sub-network unit, (ii) determining whether the fourth sub-network unit duplicates operation of the third sub-network unit within the second threshold, and/or (iii) if the fourth sub-network unit duplicates the operation of the third sub-network unit within the second threshold, substituting the third sub-network unit with the fourth sub-network unit.

The fourth sub-network unit may be obtained by (i) searching the sub-network unit repository using search criteria to obtain search results, the search criteria including characteristics of data sources and/or latent representation generation units similar to those associated with the third sub-network unit, and/or (ii) selecting the fourth sub-network unit from the search results, the search results including any number of sub-network units. Obtaining the fourth sub-network unit may also include querying another entity responsible for searching the sub-network unit repository for potential replacement sub-network units.

Determining whether the fourth sub-network unit duplicates the operation of the third sub-network unit within the threshold may be performed via methods similar to those described with respect to operation 304.

The third sub-network unit may be substituted with the fourth sub-network unit via methods similar to those described with respect to operation 306.

Following operation 312, the method may proceed to operation 308. The updated inference model may be executed via methods similar to those described above with respect to operation 308.

The method may end following operation 308.

Any of the components illustrated in FIGS. 1-2G may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high-level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random-access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a Wi-Fi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also, a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs, or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method of managing an inference model that comprises sub-network units, the method comprising:
making an identification that a portion of the inference model comprising one or more data sources of a first set of data sources is unavailable, the first set of the data sources providing first input data to a first sub-network unit of the sub-network units and when the one or more data sources are unavailable, the inference model is unable to generate an inference model result;
making a first determination, in response to the identification, regarding whether a second sub-network unit duplicates operation of the first sub-network unit within a threshold, the second sub-network unit not being used by the inference model when the identification is made;
in a first instance of the first determination in which the second sub-network unit duplicates the operation of the first sub-network unit within the threshold:
replacing, at least temporarily, the first sub-network unit with the second sub-network unit to obtain an updated inference model; and
executing the updated inference model to obtain the inference model result.

2. The method of claim 1, further comprising:
in a second instance of the first determination in which the second sub-network unit does not duplicate the operation of the first sub-network unit within the threshold:
replacing, at least temporarily, the first sub-network unit with the second sub-network unit;
replacing, at least temporarily, at least a third sub-network unit of the sub-network units with a fourth sub-network unit to obtain the updated inference model, the third sub-network unit being a portion of the inference model that sources second input data from the first sub-network unit and the fourth sub-network unit being intended to source third input data from the second sub-network unit; and
executing the updated inference model to obtain the inference model result.

3. The method of claim 2, wherein the second sub-network unit sources fourth input data from a second set of the data sources, the second set of the data sources being different from the first set of the data sources.

4. The method of claim 1, wherein when a first data source of the first set of the data sources becomes unavailable, a second data source of the first set of the data sources has an increased likelihood of becoming unavailable.

5. The method of claim 3, wherein the first sub-network unit comprises a first set of latent representation generation units and the second sub-network unit comprises a second set of latent representation generation units.

6. The method of claim 5, wherein each latent representation generation unit of the first set of the latent representation generation units is trained to generate a reduced-size representation of the first input data obtained from the first set of the data sources.

7. The method of claim 6, wherein making the first determination comprises:
obtaining the second sub-network unit from a sub-network unit repository;
obtaining, using the second sub-network unit and the fourth input data obtained from the second set of the data sources, a first reduced-size representation of the fourth input data;
comparing the first reduced-size representation of the fourth input data to an expected reduced-size representation of the second input data, the expected reduced-size representation of the second input data being generated by the first sub-network unit using the second input data obtained from the first set of the data sources; and
in an instance of the comparing in which the first reduced-size representation of the fourth input data matches the expected reduced-size representation of the second input data within the threshold:
concluding that the second sub-network unit duplicates the operation of the first sub-network unit within the threshold.

8. The method of claim 7, further comprising:
prior to making the identification:
obtaining the inference model.

9. The method of claim 8, wherein obtaining the inference model comprises:
obtaining a plurality of data sources;
for each data source of the plurality of the data sources:
making a second determination, based on an intended use of fifth input data supplied by the data source and a quantity of the fifth input data supplied by the data source, regarding whether a latent representation of the fifth input data supplied by the data source is to be used;
in a first instance of the second determination in which the latent representation of the fifth input data supplied by the data source is to be used:
obtaining a latent representation generation unit; and
obtaining a fifth sub-network unit that comprises the latent representation generation unit.

10. The method of claim 9, wherein obtaining the inference model further comprises:
in a second instance of the second determination in which the latent representation of the fifth input data supplied by the data source is not to be used:
treating the fifth input data supplied by the data source as ingest for a sixth sub-network unit of the inference model, the fifth input data supplied by the data source not being fed into a latent representation generation unit prior to being used by the sixth sub-network unit.

11. The method of claim 8, wherein obtaining the inference model further comprises:
grouping data sources of the plurality of the data sources based on likelihoods of multiple of the data sources becoming unavailable at same points in time to obtain sets of data sources that comprise portions of the data sources that are likely to become unavailable at the same points in time, and the first set of data sources being one of the sets of the data sources;
training, for the first set of the data sources, an autoencoder; and
using a portion of the autoencoder as the first sub-network unit.

12. A non-transitory machine-readable medium having instructions stored therein, which when executed by a processor, cause the processor to perform operations for managing an inference model that comprises sub-network units, the operations comprising:
making an identification that a portion of the inference model comprising one or more data sources of a first set of data sources is unavailable, the first set of the data sources providing first input data to a first sub-network unit of the sub-network units and when the one or more data sources are unavailable, the inference model is unable to generate an inference model result;
making a first determination, in response to the identification, regarding whether a second sub-network unit duplicates operation of the first sub-network unit within a threshold, the second sub-network unit not being used by the inference model when the identification is made;
in a first instance of the first determination in which the second sub-network unit duplicates the operation of the first sub-network unit within the threshold:
replacing, at least temporarily, the first sub-network unit with the second sub-network unit to obtain an updated inference model; and
executing the updated inference model to obtain the inference model result.

13. The non-transitory machine-readable medium of claim 12, wherein the operations further comprise:
in a second instance of the first determination in which the second sub-network unit does not duplicate the operation of the first sub-network unit within the threshold:
replacing, at least temporarily, the first sub-network unit with the second sub-network unit;
replacing, at least temporarily, at least a third sub-network unit of the sub-network units with a fourth sub-network unit to obtain the updated inference model, the third sub-network unit being a portion of the inference model that sources second input data from the first sub-network unit and the fourth sub-network unit being intended to source third input data from the second sub-network unit; and
executing the updated inference model to obtain the inference model result.

14. The non-transitory machine-readable medium of claim 13, wherein the second sub-network unit sources fourth input data from a second set of the data sources, the second set of the data sources being different from the first set of the data sources.

15. The non-transitory machine-readable medium of claim 12, wherein when a first data source of the first set of the data sources becomes unavailable, a second data source of the first set of the data sources has an increased likelihood of becoming unavailable.

16. The non-transitory machine-readable medium of claim 14, wherein the first sub-network unit comprises a first set of latent representation generation units and the second sub-network unit comprises a second set of latent representation generation units.

17. A data processing system, comprising:
a processor; and
a memory coupled to the processor to store instructions, which when executed by the processor, cause the processor to perform operations for managing an inference model that comprises sub-network units, the operations comprising:
making an identification that a portion of the inference model comprising one or more data sources of a first set of data sources is unavailable, the first set of the data sources providing first input data to a first sub-network unit of the sub-network units and when the one or more data sources are unavailable, the inference model is unable to generate an inference model result;
making a first determination, in response to the identification, regarding whether a second sub-network unit duplicates operation of the first sub-network unit within a threshold, the second sub-network unit not being used by the inference model when the identification is made;
in a first instance of the first determination in which the second sub-network unit duplicates the operation of the first sub-network unit within the threshold:
replacing, at least temporarily, the first sub-network unit with the second sub-network unit to obtain an updated inference model; and
executing the updated inference model to obtain the inference model result.

18. The data processing system of claim 17, wherein the operations further comprise:
in a second instance of the first determination in which the second sub-network unit does not duplicate the operation of the first sub-network unit within the threshold:
replacing, at least temporarily, the first sub-network unit with the second sub-network unit;
replacing, at least temporarily, at least a third sub-network unit of the sub-network units with a fourth sub-network unit to obtain the updated inference model, the third sub-network unit being a portion of the inference model that sources second input data from the first sub-network unit and the fourth sub-network unit being intended to source third input data from the second sub-network unit; and
executing the updated inference model to obtain the inference model result.

19. The data processing system of claim 18, wherein the second sub-network unit sources fourth input data from a second set of the data sources, the second set of the data sources being different from the first set of the data sources.

20. The data processing system of claim 17, wherein when a first data source of the first set of the data sources becomes unavailable, a second data source of the first set of the data sources has an increased likelihood of becoming unavailable.
